(19) United States
(12) Patent Application Publication
(10) Pub. No.: US 2025/0200590 A1
(43) Pub. Date: Jun. 19, 2025

(54) METHODS, SYSTEMS, AND APPARATUSES FOR GENERATING CUSTOMIZED CONTENT

(71) Applicant: PRophet, New York, NY (US)

(72) Inventors: Aaron Kwittken, New York, NY (US); Shandra Naegle, New York, NY (US)

(21) Appl. No.: 18/978,603

(22) Filed: Dec. 12, 2024

Related U.S. Application Data
(60) Provisional application No. 63/610,729, filed on Dec. 15, 2023.

(51) Int. Cl. G06Q 30/0201

(52) U.S. Cl. CPC G06Q 30/0201

(57) ABSTRACT

Methods, apparatuses, and systems are described for generating customized content such as pitch communications, tailored pitch emails, press releases, customized user biographies, and posts, such as blog posts, byline posts, and social media posts. A content platform may be configured to use one or more machine learning models to generate the customized content based one or more user inputs and send the customized content to one or more target recipients.

### CROSS-REFERENCE TO RELATED APPLICATION

This application claims the priority benefit of U.S. Provisional Application No. 63/610,729, filed Dec. 15, 2023, the entirety of which is incorporated herein by reference.

### BACKGROUND

Creating meaningful and targeted content within an efficient time frame and distributing the content to appropriate recipients has become excessively difficult, especially in today's market where people are constantly being sent a plurality of content, advertisements, commercials, communications, and messages that may not be relevant to the individual. Conventional systems and methods used by existing content platforms to provide such content do not efficiently or adequately determine the most important types of content for different target recipients. Moreover, creating customized communications and messages for each target recipient can be time consuming. Data for each target recipient must be gathered in order to determine one or more correlations between the recipient's likes and interests and then content can be customized in order to target each recipient's likes and interests to increase the chances that the recipient would be interested in consuming the content. In one example, content creators face similar issues when pitching meaningful new concepts, such as media articles, biographies, blog posts, and/or user documents to targeted recipients such as a journalist or a podcast creator.

As such, generating natural language from machine representation systems is a common and increasingly important function. Existing natural language generation (NLG) systems, such as translators, summarizers, dialog generators, etc., while common, cannot produce variable output based on user-desired tunable specifications. Additionally, such existing systems cannot take input in the form of a variable form of text and a variable set of specifications and output a transformed version of the input text according to the specifications. Further, such existing systems are generally not readily extendable. Conventional NLG systems simply generate tunable stylized text (such as, for example, one or more sentences) by transforming received user text input and one or more user-originated stylistic parameters (directed to polarity of subjective opinion, such as sentiments, valence, emotions, formal, business, readability, etc.) in vector form, using unsupervised natural language processing (NLP) systems such as rule-based and/or machine learning-based classifiers and/or regressors, metric computation systems as style scorers, etc.

### SUMMARY

It is to be understood that both the following general description and the following detailed description are exemplary and explanatory only and are not restrictive.

Methods, systems, and apparatuses for generating customized content and sending the customized content to one or more target recipients are described herein. A content platform may comprise a system of computing devices, servers, software, etc. that is configured to use one or more machine learning models (e.g., generative artificial intelligence, predictive artificial intelligence, neural networks, deep-learning models, text-based learning models, large language models, natural language processing applications/models, etc.) to generate customized content based one or more user inputs and send the customized content to one or more target recipients (e.g., global journalists, podcast creators, and/or influencers). The customized content may include one or more of a pitch communication, a tailored pitch email, a templated press release, a user biography, and/or a post, such as a blog post, a byline post, and/or a social media post. The system may generate the pitch communication based on a content item, such as a media article, a blog post, or a user document (e.g., media lists). In addition, the system may track one or more engagement metrics associated with the one or more target recipients interacting with the pitch communication. The system may generate a tailored pitch email based on content items associated with a target recipient and based on the pitch communication. The system may generate the templated press release based on the pitch communication and based on one or more user inputs associated with the pitch communication. The system may generate the user biography based on a type of event, such as a presentation or webinar, and a user profile associated with a webpage. The system may generate the post based on any data or statistics available online as well as a product designation and/or keyword. In addition, the system may also generate social media posts based on a topic provided and a social media platform selected. In an embodiment, are methods for utilizing generative artificial intelligence (AI) to facilitate public relations (PR) activities comprising receiving, by a computing device, information associated with content item, generating, by a generative AI module, based on the information, a pitch communication, determining, by a predictive AI module, based on the pitch communication, one or more target recipients, and facilitating, by the computing device, transmission of the pitch communication to the one or more target recipients.

In an embodiment, are methods for generating a customized biography for a user comprising receiving input indicating a type of event associated with a biography, receiving one or more user preferences associated with one or more areas of emphasis comprising at least one of an education, a personal interest, or a previous role, extracting data from an existing user profile including at least a name, a current job title, a company, and a location, and generating, via a generative artificial intelligence (AI) module, a biography associated with the type of event and the one or more user preferences.

In an embodiment, are methods for generating a post using a generative artificial intelligence (AI) system comprising receiving, via a user interface, an input comprising at least one of: a product designation or a keyword, accessing, by a generative AI system, a database storing a plurality of statistical data and reference sources, selecting, by the generative AI system, at least one statistic based on the received product designation or keyword, wherein the at least one statistic has an associated reference source indicating an origin of the at least one statistic, generating, by the generative AI system, a post comprising content that is structured around the at least one statistic and the received product designation or keyword, incorporating, within the generated post, a footnote that references the associated reference source of the at least one statistic, and presenting, via the user interface, the generated post.

In an embodiment, are methods for generating social posts using generative artificial intelligence (AI) system comprising receiving, via a user interface, an input comprising at least one of: a topic or a social media platform designation, accessing, by a generative AI module, a database storing a plurality of statistical data and reference sources, selecting, by the generative AI module, at least one statistic based on the received topic, wherein the at least one statistic has an associated reference source indicating an origin of the at least one statistic, generating, by the generative AI module, a social media post comprising content that is structured around the at least one statistic and the topic and that is tailored to the social media platform, incorporating, within the generated social media post, a footnote that references the associated reference source of the at least one statistic and an indication of content related to the topic, and presenting, via the user interface, the generated social media post.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system;

FIG. 2 shows example system architecture;

FIG. 3 shows an example user interface;

FIG. 4 shows an example user interface;

FIG. 5 an example user interface;

FIG. 6 shows an example machine learning system;

FIG. 7 shows a flowchart of an example machine learning method;

FIG. 8 shows a flowchart of an example method;

FIG. 9 shows a flowchart of an example method;

FIG. 10 shows a flowchart of an example method; and

FIG. 11 shows a flowchart of an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

Creating meaningful and targeted content within an efficient time frame and distributing the content to appropriate recipients has become excessively difficult, especially in today's market where people are constantly being sent a plurality of content, advertisements, commercials, communications, and messages that may not be relevant to the individual. Conventional systems and methods used by existing content platforms to provide such content do not efficiently or adequately determine the most important types of content for different target recipients. Moreover, creating customized communications and messages for each target recipient can be time consuming. Data for each target recipient must be gathered in order to determine one or more correlations between the recipient's likes and interests and then content can be customized in order to target each recipient's likes and interests to increase the chances that the recipient would be interested in consuming the content. In one example, content creators face similar issues when pitching meaningful new concepts, such as media articles, biographies, blog posts, and/or user documents to targeted recipients such as a journalist or a podcast creator.

Thus, machine learning systems have been increasingly implemented in order to generate customized text-based communications. Existing natural language generation (NLG) systems, such as translators, summarizers, dialog generators, etc., while common, cannot produce variable output based on user-desired tunable specifications. Specifically, these existing NLG systems simply generate tunable stylized text (such as, for example, one or more sentences) by transforming received user text input and one or more user-originated stylistic parameters (directed to polarity of subjective opinion, such as sentiments, valence, emotions, formal, business, readability, etc.) in vector form, using unsupervised natural language processing (NLP) systems such as rule-based and/or machine learning-based classifiers and/or regressors, metric computation systems as style scorers, etc. These existing NLG systems are simply not capable of receiving deferent forms, or types, of user inputs, that include text, images, audio, and the like, and output a transformed version of the user input.

Moreover, conventional computing systems lack an efficient computing architecture in order to implement these existing NLG systems. For example, these conventional computing systems are unreliable inefficient, and lack scalable data systems. In addition, these conventional computing system lack the ability to properly secure data, such as user profile data that may include sensitive personal information of the user. Thus, these conventional computing systems do not operate effectively in order to implement the NLG systems because they are prone to inaccurate data management that leads to improperly generating customized content that do not accurately target intended recipients and are prone to the inadvertent release of sensitive personalized data to third parties.

By way of example, the present methods and systems address these challenges by generating customized content and sending the customized content to one or more target recipients via a computing system, that includes a data layer computing architecture, and that is configured to implement NLP systems. For example, a content platform may comprise a system of computing devices, servers, software, etc. that is configured to use one or more machine learning models (e.g., generative artificial intelligence, predictive artificial intelligence, neural networks, deep-learning models, text-based learning models, large language models, natural language processing applications/models, etc.) to generate customized content based one or more user inputs and send the customized content to one or more target recipients (e.g., global journalists, podcast creators, and/or influencers).

This approach allows for the seamless generation of one or more of a pitch communication, a tailored pitch email, a templated press release, a user biography, and/or a post, such as a blog post, a byline post, and/or a social media post. The system may generate the pitch communication based on a content item, such as a media article, a blog post, or a user document (e.g., media lists). The system may generate a tailored pitch email based on content items associated with a target recipient and based on the pitch communication. The system may generate the templated press release based on the pitch communication and based on one or more user inputs associated with the pitch communication. The system may generate the user biography based on a type of event, such as a presentation or webinar, and a user profile associated with a webpage. The system may generate the post based on any data or statistics available online as well as a product designation and/or keyword. In addition, the use of a data layer architecture improves several aspects of a computing device such as improved reliability by ensuring continuous availability of data preventing system downtime and enhancing user trust, improved scalability by utilizing the efficient handling of growing datasets and increasing user demand, improved performance by utilizing an optimized data flow that reduces latency and accelerates responses, and improved data integrity by providing consistent and secure data handling across all layers insuring accuracy and compliance. By integrating diverse data systems, including flat files, caching, data lakes, and relational databases, the data layer computing architecture ensures a balance of speed, flexibility, and persistence.

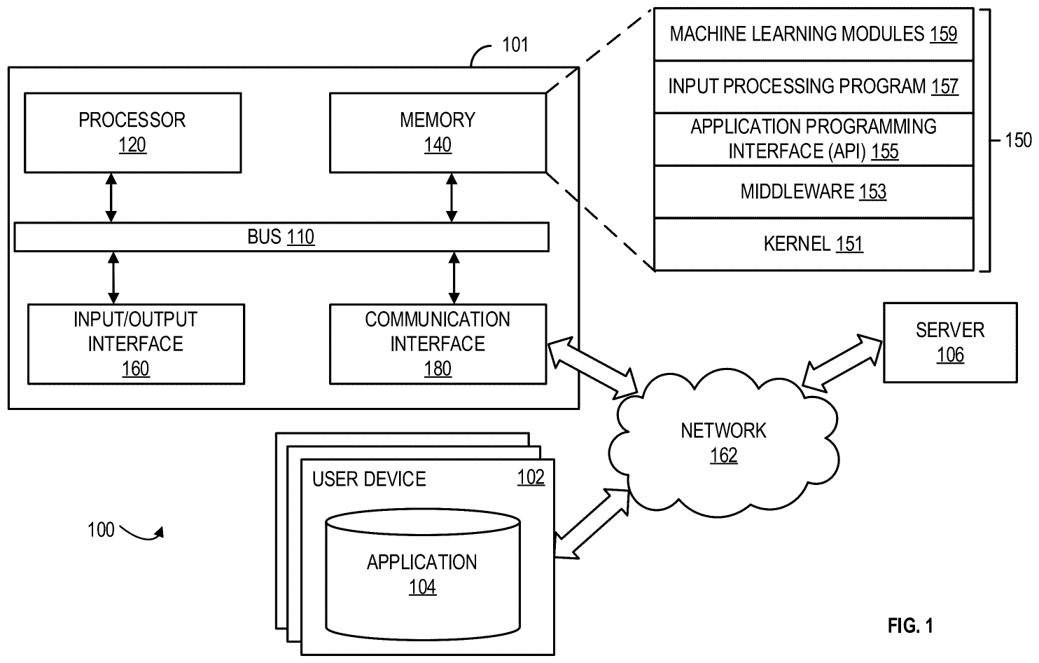

FIG. 1 shows an example system 100 for generating customized content (e.g., a pitch communication, a user biography, and/or a blog post) based on information associated with one or more content items. The customized content may comprise one or more of a pitch communication, a tailored pitch email, a templated press release communication, a user biography, and/or a post, such as a blog post, a byline post, and/or a social media post. In an example, the pitch communication may be generated based on a content item, such as a media article, a blog post, or a user document (e.g., media lists). In addition, one or more engagement metrics may be tracked, wherein the one or more engagement metrics may be associated with the one or more target recipients interacting with the pitch communication. In an example, the tailored pitch email may be generated one or more content items associated with a target recipient and based on the pitch communication. In an example, the templated press release communication may be generated based on the pitch communication and based on one or more user inputs associated with the pitch communication. In an example, the user biography may be generated based on a type of event, such as a presentation, and a user profile associated with a webpage. In an example, the post may be generated based on a product designation or keyword. The system 100 may include a backend platform device 101, a user device 102, and one or more external servers 106. In an example, the backend platform device 101 may be configured to receive one or more user inputs and generate, based on one or more machine learning models, customized content and send the customized content to one or more target recipients. In an example, the backend platform device 101 may be in communication with the user device 102, and the one or more external servers 106 via a network (e.g., network 162).

The backend platform device 101 may include a bus 110, one or more processors 120, a memory 140, an input/output interface 160, and a communication interface 180. In certain examples, the backend platform device 101 may omit at least one of the aforementioned elements or may additionally include other elements. The backend platform device 101 may comprise, for example, a host server capable of processing the user inputs in order to generate and distribute the customized content.

The bus 110 may comprise a circuit for connecting the bus 110, the one or more processors 120, the memory 140, the input/output interface 160, and/or the communication interface 180 to each other and for delivering communication (e.g., a control message and/or data) between the bus 110, the one or more processors 120, the memory 140, the input/output interface 160, and/or the communication interface 180.

The one or more processors 120 may include one or more of a Central Processing Unit (CPU), an Application Processor (AP), or a Communication Processor (CP). The one or more processors 120 may control, for example, at least one of the bus 110, the memory 140, the input/output interface 160, and/or the communication interface 180 of the backend platform device 101 and/or may execute an arithmetic operation or data processing for communication. As an example, the one or more processors 120 may cause the backend platform device 101 to process the user input via the input processing program 157 and the machine learning programs/models 159 in order to generate and/or distribute the customized content. The processing (or controlling) operation of the one or more processors 120 according to various embodiments is described in detail with reference to the following drawings.

The processor-executable instructions executed by the one or more processors 120 may be stored and/or maintained by the memory 140. The memory 140 may include a volatile and/or non-volatile memory. The memory 140 may include random-access memory (RAM), flash memory, solid state or inertial disks, or any combination thereof. As an example, the memory 140 may include an Embedded MultiMedia Card (eMMC). The memory 140 may store, for example, a command or data related to at least one of the bus 110, the one or more processors 120, the memory 140, the input/output interface 160, and/or the communication interface 180 of the backend platform device 101. According to various examples, the memory 140 may store software and/or a program 150 or may comprise firmware. For example, the program 150 may include a kernel 151, a middleware 153, an Application Programming Interface (API) 155, an input processing program 157, and/or machine learning programs/models 159, and/or the like, configured for controlling one or more functions of the backend platform device 101 and/or an external device (e.g., the one or more servers 106). At least one part of the kernel 151, middleware 153, or API 155 may be referred to as an Operating System (OS). The memory 140 may include a computer-readable recording medium (e.g., a non-transitory computer-readable medium) having a program recorded therein to perform the methods according to various embodiments by the one or more processors 120. In an example, the memory 140 may store the customized content.

The kernel 151 may control or manage, for example, system resources (e.g., the bus 110, the one or more processors 120, the memory 140, etc.) used to execute an operation or function implemented in other programs (e.g., the middleware 153, the API 155, the input processing program 157, or the machine learning program/model 159). Further, the kernel 151 may provide an interface capable of controlling or managing the system resources by accessing individual elements of the data capture device 101 in the middleware 153, the API 155, the input processing program 157, or the machine learning program/model 159.

The middleware 153 may perform, for example, a mediation role, so that the API 155, the input processing program 157, and/or the machine learning programs/models 159 can communicate with the kernel 151 to exchange data. Further, the middleware 153 may handle one or more task requests received from the input processing program 157 and/or the machine learning programs/models 159 according to a priority. For example, the middleware 153 may assign a priority of using the system resources (e.g., the bus 110, the one or more processors 120, or the memory 140) of the backend platform device 101 to at least one of the input processing program 157 and/or the machine learning programs/models 159. For example, the middleware 153 may process the one or more task requests according to the priority assigned to at least one of the application programs, and thus, may perform scheduling or load balancing on the one or more task requests.

The API 155 may include at least one interface or function (e.g., instruction), for example, for file control, window control, video processing, and/or character control, as an interface capable of controlling a function provided by the input processing program 157 and/or the machine learning program/model 159 in the kernel 151 or the middleware 153.

As an example, the input processing program 157 and the machine learning programs/models 159 may be independent of each other or integrally combined, in whole or in part.

The input processing program 157 may include logic (e.g., hardware, software, firmware, etc.) that may be implemented to process one or more user inputs received from one or more users, such as via one or more user devices 102. The user devices 102 may comprise a laptop computer, a mobile phone, a smart phone, a tablet computer, a wearable device, a smartwatch, a desktop computer, a smart television, and the like. The user devices 102 may be configured to include an application 104 for providing the user input. In an example, the application 104 may comprise a mobile application or a web browser. The user device 102 may execute the application 104, wherein the application 104 may cause the user device 102 to output a user interface that may include a prompt for the user to provide the user inputs. For example, the user may provide text input (e.g., topic(s), keyword(s), etc.) or one or more content items. For example, the content items may comprise one or more of media articles, blog posts, user documents (e.g., media lists), webpages, and the like. The user device 102 may send the user input to the backend platform device 101, wherein the backend platform device 101 may generate customized content based on the user input. The input processing program 157 may be configured to use one or more machine learning modules/models 159 to generate customized content based on the user input. The customized content may comprise one or more of a pitch communication, a tailored pitch email, a templated press release communication, a user biography, and/or a post (e.g., a blog post, a byline post, and/or a social media post).

In example, the input processing program 157 may generate a pitch communication based on one or more of text input and/or a content item received from the user device 102 via the application 104. The content item may comprise one or more of a media article, a blog post, or a user document (e.g., media lists). The pitch communication may be related to, or associated with, a potential media placement for the content item. The input processing program 157 may process the content item to determine information associated with the content item. The input processing program 157 may process the information via a generative artificial intelligence (AI) module of the machine learning modules/models 159 and generate the pitch communication based on the information. For example, the generative AI module may analyze the information to identify thematic elements. The generative AI module may determine a narrative encompassing the identified thematic elements. The generative AI module may generate the pitch communication based on the narrative. The input processing program 157 may process the generated pitch communication via a predictive AI module of the machine learning modules/models 159. For example, the predictive AI module may analyze the pitch communication to determine one or more target recipients. The target recipients may comprise journalists, podcast creators, influencers and the like. As an example, the predictive AI module may determine the one or more target recipients based on recipient receptiveness associated with the one or more recipients. The predictive AI module may analyze the pitch communication to determine the recipient receptiveness associated with the one or more recipients. As an example, the predictive AI module may determine the one or more target recipients based on predictive potential recipients. The predictive AI module may analyze a plurality of recipient profiles to identify one or more potential recipients based on historical receptiveness data and thematic preferences. The predictive AI module may evaluate an alignment between the pitch communication and the one or more potential recipients using predictive analytics. Based on the evaluative analysis, the predictive AI module may determine the one or more target recipients of the one or more potential recipients predicted to be most receptive to the pitch communication. The plurality of recipient profiles may comprise data accumulated from a plurality sources comprising one or more of media publications, social media platforms, or previous engagement histories. The predictive AI module may be configured to employ a sentiment analysis algorithm to gauge potential receptiveness of the one or more potential recipients based on their recent publications and social media sentiment. The input processing program 157 may cause the backend platform device 101 to output (e.g., transmit) the pitch communication to the one or more target recipients. In an example, an alert notification (e.g., email, text messages, etc.) may be generated when the pitch communication is generated. In another example, an alert notification (e.g., email, text messages, etc.) may be generated based on one or more users interacting with the pitch communication. The alert notifications may be sent to the user device 102 that prompted the generated pitch communication. In another example, an alert notification (e.g., email, text messages, etc.) may be generated based on monitoring topics, categories, keywords, brand mentions, etc. across one or more media sources (e.g., e.g., media outlets, media publications, social media platforms, etc.). For example, a user may provide user input selecting one or more of the topics, categories, keywords, brand mentions, etc. to monitor and receive an alert based one or more of the topics, categories, keywords, brand mentions, etc. that appear via one or more of the media sources.

As an example, the input processing program 157, via the generative AI module, may further generate one or more tailored/personalized pitch emails based on one or more content items associated with each target recipient of the one or more target recipients and based on the pitch communication. For example, the input processing program 157, via the generative AI module, may generate personalized pitch emails for each target recipient. One or more inputs associated with each tailored pitch email of the one or more tailored pitch emails may be received. The input processing program 157 may cause the backend platform device 101 to facilitate transmission of the one or more tailored pitch emails to the one or more target recipients based on the one or more inputs associated with each tailored pitch email. For example, the user may provide one or more user inputs editing one or more of the tailored pitch emails before the backend platform device 101 sends the one or more tailored pitch emails to the one or more target recipients.

As an example, the backend platform device 101 may receive one or more user inputs associated with the pitch communication. The input processing program 157, via the generative AI module, may generate a templated press release communication based on the one or more user inputs associated with the pitch communication and the pitch communication. The input processing program 157, via the predictive AI module, may determine one or more second target recipients based on the templated press release communication. The input processing program 157 may cause the backend platform device 101 to facilitate transmission of the templated press release communication to the one or more second target recipients. As an example, the input processing program 157 may determine the one or more second target recipients based on one or more filter parameters comprising one or more of a location or a source.

As an example, the backend platform device 101 may receive response data from the target recipients. The response data may be provided to a feedback loop mechanism to update the predictive AI module. As an example, the input processing program 157 may track one or more engagement metrics (e.g., response data) associated with the one or more target recipients engaging with the pitch communication.

As an example, the pitch communication may be edited by the user that provided the user input via the application 104 of the user device 102. The backend platform device 101 may receive one or more user inputs editing the pitch communication. The input processing program 157 may analyze the edited pitch communication via the predictive AI module of the machine learning modules/models 159 to determine one or more third target recipients. The input processing program 157 may cause the backend platform device 101 to send (e.g., transmit) the edited pitch communication to the one or more third target recipients. As an example, the input processing program 157 may determine the one or more third target recipients based on one or more filter parameters comprising one or more of a location or a source.

As an example, the input processing program 157 may determine a list of target recipients of the one or more target recipients after the pitch communication and/or the press release is generated. For example, one or more “top tier” target recipients (e.g., top tier, or highest ranked, journalists) may be determined, or identified, from one or more media sources (e.g., media outlets, media publications, social media platforms, etc.). For example, by identifying top tier target recipients, the backend platform device 101 may enable users to identify which pitch communications are better suited for certain media sources. In an example, the user may provide user input selecting one or more of the target recipients. The input processing program 157 may cause the backend platform device 101 to output additional information associated with each of the selected targeted recipients. The additional information may comprise names, titles, contact information, media sources, social media handles, locations, and the like. In addition, the input processing program 157 may cause the backend platform device 101 to output one or more content items (e.g., articles) of the one or more target recipients, wherein the one or more content items are related to the pitch communication and/or the press release. In an example the input processing program 157 may generate a media list (e.g., user document) based on the user input selecting the one or more of the target recipients, wherein the media list may comprise the one or more content items.

As an example, the input processing program 157 may determine one or more results after the pitch communication and/or the press release is generated. For example, the results may comprise data indicative of one or more of the target recipients (e.g., top target recipients) and/or one or more media sources (e.g., top media outlets, top media publications, social media platforms, etc.). In an example, the results may comprise data indicative of one or more media sources with a highest unique visitor metric (UVM).

In an example, the input processing program 157 may generate a user biography based on user input (e.g., text input) and/or a webpage. The user device 102 may provide user input (e.g., text input of a type of event) associated with a user biography, one or more user preferences, and/or a webpage identifier (e.g., URL) via the application 104 to the backend platform device 101. The backend platform device 101 may receive and process the user input via the input processing program 157. The type of event may be associated with a presentation or webinar and/or topics associated with an event. The one or more user preferences may be associated with one or more areas of emphasis comprising at least one of an education, a personal interest, or a previous role. The one or more areas of emphasis may be weighted according to user preferences to prioritize information in the generated biography. The user preferences may be provided by the user device 102 based on a user profile. For example, a user profile associated with the user may be accessed when the user device 102 accesses the application 104. The user profile, or one or more user preferences based on the user profile, may be sent to the backend platform device 101 when the user provides the user input via the application 104. In an example, the one or more preferences may be provided based on an existing user profile. In an example, the input processing program 157 may extract data from the existing user profile. The data may include at least a name, a current job title, a company, and a location. In an example, the existing user profile may be based on a webpage associated with the user. The user may provide an identifier (e.g., a URL, a link, etc.) of the webpage via the application 104. The backend platform device 101 may receive the identifier of the webpage and determine the existing user profile based on the identifier of the webpage. For example, the webpage may comprise a social media webpage (e.g., a professional social media webpage) associated with the user. For example, the webpage may comprise structured data indicative of user characteristics comprising at least the name, the current job title, the company, and the location. The input processing program 157 may be configured to use the generative AI module to generate a biography associated with the type of event and the one or more user preferences. In an example, the generative AI module may be configured to utilize natural language processing to generate the biography associated with the type of event and the one or more user preferences.

As an example, the input processing program 157 may analyze the webpage to extract a profile photo from the existing user profile and incorporate the profile photo into the generated biography. As an example, the input processing program 157 may output, via the application 104 of the user device 102, an option to edit the generated biography. As an example, the input processing program 157 may format the generated biography according to a template selected based on the type of event.

In an example, the input processing program 157 may generate a post based on user input (e.g., text input associated with a product designation or a keyword). For example, the post may comprise one or more of a blog post, a byline post, or a social media post. As an example, the blog post and the byline post may comprise similar content, wherein the blog post may contain 500 or less words while the byline post may contain 500 or more words. As an example the social media post may contain content tailored for one or more social media platforms based on the user input. The user device 102 may receive an input via the application 104 (e.g., user interface) and send the input to the backend platform device 101. The input may comprise at least one of a product designation or a keyword. The input processing program 157 may use the generative AI module of the machine learning modules/models 159 to access a database storing a plurality of statistical data and reference sources and select at least one statistic based on the received product designation or keyword. The at least one statistic may have an associated reference source indicating an origin of the at least one statistic. The generative AI module may generate a post comprising content that is structured around the at least one statistic and the received product designation or keyword. In an example, the generative AI module may be configured to utilize a linguistic model to create a coherent and contextually relevant narrative surrounding the selected statistic and the received product designation or keyword. The linguistic model utilized by the generative AI module may be configured for understanding and processing natural language inputs to create grammatically correct and stylistically consistent narrative content. The input processing program 157 may incorporate a footnote that references the associated reference source of the at least one statistic within the generated post. The input processing program 157 may cause the backend platform device 101 to output (e.g., present, display, etc.) the generated post via the application 104 (e.g., user interface) of the user device 102. In an example, an alert notification (e.g., email, text messages, etc.) may be generated when the post is generated. In another example, an alert notification (e.g., email, text messages, etc.) may be generated based on one or more users interacting with the post. The alert notifications may be sent to the user device 102 that prompted the generated post.

As an example, the input processing program 157 may cause the backend platform device 101 to output (e.g., present, display, etc.) one or more options, via the application 104 (e.g., user interface) of the user device 102, associated with the generated post. The one or more options may comprise one or more of edit the post, save the post, send the post to a social media platform, or reference one or more previous generations of the post. As an example, the database storing the plurality of statistical data and reference sources may be updated to include recent statistical data and reference sources. As an example, the application 104 (e.g., user interface) may be configured to further provide (e.g., present, display, etc.) options for a user to specify additional criteria for the post generation. The additional criteria may comprise one or more of: a length of the post, a desired writing style, a topic of the post, a tone of the post, a product, a keyword, or inclusion of multimedia elements. As an example, the input processing program 157 may optimize the generated post for search engine visibility (SEO) by incorporating at least one SEO-friendly element based on the received product designation or keyword.

In an example, the input processing program 157 may generate a social media post based on user input (e.g., text input associated with a topic and a social media platform). The user device 102 may receive an input via the application 104 (e.g., user interface) and send the input to the backend platform device 101. The input may comprise a topic and a social media platform designation. The input processing program 157 may use the generative AI module of the machine learning modules/models 159 to access a database storing a plurality of statistical data and reference sources and select at least one statistic based on the received topic. The at least one statistic may have an associated reference source indicating an origin of the at least one statistic. The generative AI module may generate a social media post comprising content that is structured around the topic and the received social media platform designation. In an example, the generative AI module may be configured to utilize a linguistic model to create a coherent and contextually relevant narrative surrounding the at least one statistic and the received social media platform designation. The input processing program 157 may incorporate a footnote that references the associated reference source of the at least one statistic within the generated post. The footnote may also comprise an indication of content related to the topic. For example, the content may comprise one or more of one or more video content items associated with the topic or one or more audio content item items associated with the topic. The input processing program 157 may cause the backend platform device 101 to output (e.g., present, display, etc.) the generated social media post via the application 104 (e.g., user interface) of the user device 102. In an example, an alert notification (e.g., email, text messages, etc.) may be generated when the social media post is generated. In another example, an alert notification (e.g., email, text messages, etc.) may be generated based on one or more users interacting with the social media post. The alert notifications may be sent to the user device 102 that prompted the generated social media post.

The input/output interface 160 may include an interface for delivering an instruction or data input from a user (e.g., an operator of the backend platform device 101) or from a different external device (e.g., user device 102 or servers 106) to the different elements of the backend platform device 101. The input/output interface 160 may further include an interface for outputting one or more user interfaces to the user. For example, the input/output interface 160 may comprise a display, such as a touch screen display, and/or one or more physical input interfaces (e.g., keyboard, mouse, etc.) configured to receive user inputs. Further, the input/output interface 160 may output an instruction or data received from one or more elements of the backend platform device 101 to one or more external devices (e.g., user device 102 or servers 106).

The communication interface 180 may establish, for example, communication between the data capture device 101 and one or more external devices (e.g., the user device 102 and/or the server 106). For example, the communication interface 180 may communicate with the one or more external devices (e.g., the user device 102 and/or the servers 106) by being connected to a network 162 through wireless communication or wired communication. The network 162 may include, for example, at least one of a telecommunications network, a computer network (e.g., LAN or WAN), the Internet, and/or a telephone network.

The communication interface 180 may be configured to communicate with the one or more external devices (e.g., user device 102 or server 106) via the network 162 (e.g., Internet, LAN, etc.). In an example, the communication interface 180 may be configured to access the network 162 via a wireless communication interface such as a cellular communication protocol. The cellular communication protocol may comprise at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the wireless communication interface may be configured to use a near-distance communication. The near-distance communication interface may include for example, at least one of Wireless Fidelity (WiFi), Bluetooth, Bluetooth Low Energy (BLE), Near Field Communication (NFC), Global Navigation Satellite System (GNSS), and the like. According to a usage region or a bandwidth or the like, the GNSS may include, for example, at least one of Global Positioning System (GPS), Global Navigation Satellite System (GLONASS), BeiDou Navigation Satellite System (BDS), Galileo, the European global satellite-based navigation system, and the like. Hereinafter, the “GPS” and the “GNSS” may be used interchangeably in the present document.

The external servers 106 may include a group of one or more external servers. For example, all or some of the operations executed by the backend platform device 101 may be executed in a different server or a plurality of external servers 106. In an example, if the backend platform device 101 needs to perform a certain function or service either automatically or based on a request, the backend platform device 101 may request at least some parts of functions related thereto alternatively or additionally to a different server 106 or plurality of external servers 106 instead of executing the function or the service autonomously. One or more of the external servers 106 may execute the requested function or additional function, and may deliver a result thereof to the backend platform device 101. The backend platform device 101 may provide the requested function or service either directly or by additionally processing the received result. For example, a cloud computing, distributed computing, or client-server computing technique may be used.

In an example, the backend platform device 101 and/or the external servers 106 may include one or more databases. For example, the databases may be used to store a plurality of user profiles associated with a plurality of users and/or a plurality of target recipients. The user profiles may comprise information associated with the users and/or target recipients that may be used to determine one or more preferences associated with the users and/or target recipients. In an example, the user profiles associated with the target recipients may comprise names, titles, contact information, media sources, social media handles, locations, and the like of the target recipients. For example, user profiles may be used to identify different areas of emphasis associated with the users such as education, personal interests, or previous roles. For example, recipient user profiles may be associated with the target recipients that may be used to determine potential recipients that would be most interested in consuming the generated pitch communications. In an example, the recipient profiles may be used to generate tailored pitch emails for specific target recipients. In an example, the database may store tracking information associated with one or more engagement metrics associated with the one or more target recipients' interactions with the pitch communications and/or one or more engagement metrics associated with user/viewer interactions with the user biographies and/or blog posts. In an example, the database may store a plurality of statistical data and reference sources. A statistic may have an associated reference source indicating an origin of the at least one statistic, for example.

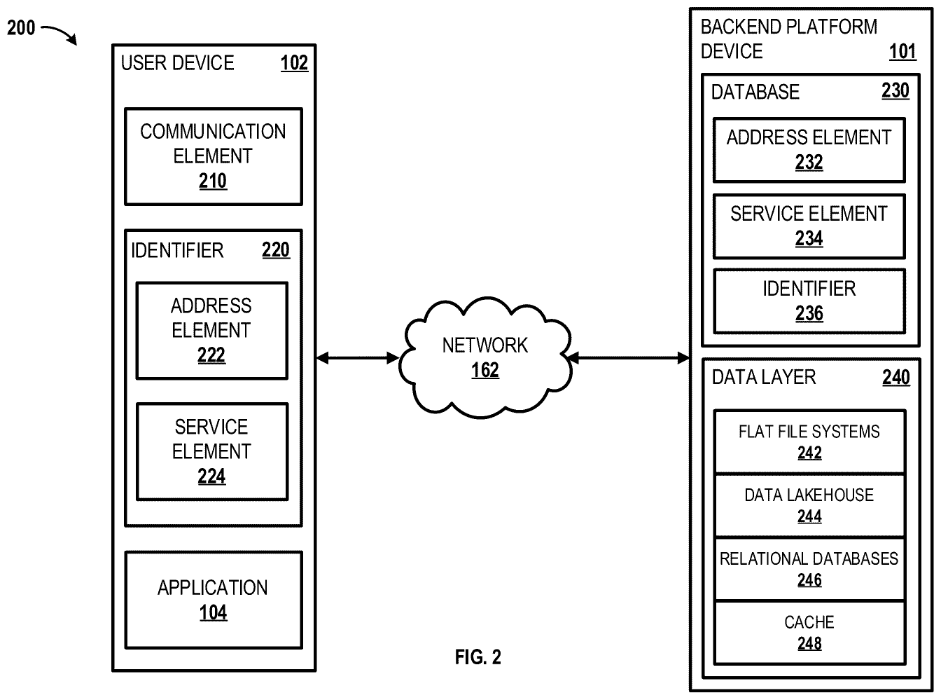

FIG. 2 shows example system architecture 200 for generating (e.g., a pitch communication, a user biography, and/or a blog post) customized content based on receiving user input from one or more user devices (e.g., user devices 102). The system architecture 200 may be configured to provide services, such as content generation services to one or more user devices 102. The system architecture 200 may comprise one or more user devices 102 and a backend platform device 101. The backend platform device 101may be disposed locally or remotely relative to the user devices 102. The user devices 102 and the backend platform device 101, such as a centralized device or a server, may be in communication via a private and/or public network 162 such as the Internet or a local area network (LAN). Other forms of communications can be used such as wired and wireless telecommunication channels.

The user devices 102 may comprise electronic devices such as a laptop computer, a mobile phone, a smart phone, a tablet computer, a wearable device, a smartwatch, a desktop computer, a smart television,, or other device capable of connecting to the network 162. The user devices 102 may comprise a communication element 210, an identifier 220, and an application 104.

The communication element 210 may comprise a wireless transceiver configured to transmit and receive wireless communications via a wireless communication network. The communication element 210 may be configured to communicate via a specific network protocol. The communication element 210 may comprise a wireless transceiver configured to communicate via a Wi-Fi network. The user devices 102 may communicate with the backend platform device 101, and/or a user device via the communication element 210.

The user devices 102 may be associated with user identifiers or device identifiers 220. As an example, the device identifiers 220 may be any identifier, token, character, string, or the like, for differentiating one user or user device (e.g., a user device 102) from another user or user device. The device identifier 220 may identify a user or user device as belonging to a particular class of users or user devices. As an example, the device identifier 220 may comprise information relating to the user device such as a manufacturer, a model or type of device, a service provider associated with the user device 102, a state of the user device 102, a locator, and/or a label or classifier. Other information can be represented by the device identifiers 220.

The device identifiers 220 may comprise address elements 222 and service elements 224. The address elements 222 may comprise or make available an internet protocol address, a network address, a media access control (MAC) address, an Internet address, or the like. As an example, the address elements 222 may be relied upon to establish a communication session between the user devices 102 and the backend platform device 101 or other devices and/or networks. As an example, the address elements 222 may be used as an identifier or locator of the user devices 102. The address elements 222 may be persistent for a particular network.

The service elements 224 may comprise identification of the service providers associated with the user devices 102 and/or with the class of user devices 102. The class of the user devices 102 may be related to a type of device, a capability of a device, a type of service being offered, and/or a level of service (e.g., a business class, a service tier, a service package, etc.). As an example, the service elements 224 may comprise information relating to or made available by a communication service provider (e.g., an Internet service provider) that is offering or enabling data flow such as communication services to the user devices 102. As an example, the service elements 224 may comprise information relating to a preferred service provider for one or more particular services relating to the user devices 102. The address elements 222 may be used to identify or retrieve data from the service elements 224, or vice-versa. As an example, one or more of the address elements 222 and the service elements 224 can be stored remotely from the user devices 102 and retrieved by one or more devices such as the user devices 102 and the backend platform device 101. Other information can be represented by the service element 224.

The user devices 102 may implement an application 104 to provide user input that may be output to the backend platform device 101 for generating customized content. For example, a user device 102 may execute the application 104, wherein the application 104 may cause the user device 102 to output a user interface that may include a prompt for the user to provide the user inputs. For example, the user may provide text input (e.g., topic(s), keyword(s), etc.) or one or more content items. For example, the content items may comprise one or more of media articles, blog posts, user documents (e.g., media lists), webpages, and the like. The user device 102 may send the user input to the backend platform device 101, wherein the backend platform device 101 may generate customized content based on the user input. The user device 102 may receive the generated customized content from the backend platform device 101, wherein the user device 102 may output a user interface configured to display the customized content. In an example, the customized content may be edited by the user based on the user providing user input via the application 104 of the user device 102.

The backend platform device 101 may comprise a server (e.g., a host server), or a centralized device, for communicating with the user devices 102 and for processing the user inputs received from the user device 102 in order to generate and distribute the customized content. In an example, the backend platform device 101 may communicate with the user devices 102 for offering data and/or services. For example, the backend platform device 101 may offer services such as network (e.g., Internet) connectivity, network printing, media management (e.g., a media server), interference management, content generation services, streaming services, broadband services, or other network-related services.

The backend platform device 101 may allow the user devices 102 to interact with remote resources such as data, devices, and files. As an example, the backend platform device 101 may be configured as (or disposed at) a central location (e.g., a headend, or a processing facility), which can receive content (e.g., data, input programming) from multiple sources. The backend platform device 101 may be a separate/remote device from the headend, for example. The backend platform device 101 can combine content from the multiple sources and may distribute the content to user locations via a distribution system.

The backend platform device 101 may be configured to manage the communication between the user devices 102 and a storage system (e.g., a database 230) and a data layer 240 for sending and receiving data there in between. As an example, the database 230 may store a plurality of files, user identifiers or records, or other information. As an example, the user devices 102 may request and/or retrieve one or more files from the database 230. The database 230 may store information relating to the user devices 102 such as the address elements 222 and/or the service elements 224. As an example, the backend platform device 101 may obtain the device identifiers 230 from the user devices 102 and retrieve information from the database 230 such as the address elements 222 and/or the service elements 224. As an example, the backend platform device 101 may obtain the address elements 222 from the user devices 102 and may retrieve the service elements 224 from the database 230, or vice versa. Any information can be stored in and retrieved from the database 230. The database 230 can be disposed remotely from the backend platform device 101 and accessed via direct or indirect connection. The database 230 can be integrated with the backend platform device 101 or some other device or system.

The backend platform device 101 may have an address element 232 and a service element 234, which may be stored in the database 230. The address element 232 may comprise or provide an internet protocol address, a network address, a media access control (MAC) address, an Internet address, or the like. The address element 232 may be relied upon to establish a communication session between the backend platform device 101 and the user device 102 or other devices and/or networks. The address element 232 may be used as an identifier or locator of the backend platform device 101. The address element 232 may be persistent for a particular network.

The service element 234 may comprise an identification of a service provider associated with the backend platform device 101 and/or with the class of backend platform device 101. The class of the backend platform device 101 may be related to a type of device, capability of device, type of service being provided, and/or a level of service (e.g., business class, service tier, service package, etc.). The service element 234 may comprise information relating to or provided by a communication service provider (e.g., Internet service provider) that is providing or enabling data flow such as communication services to the backend platform device 101. The service element 234 may comprise information relating to a preferred service provider for one or more particular services relating to the backend platform device 101. Other information may be represented by the service element 234.

The backend platform device 101 may have an identifier 236, which may be stored in the database 230. The identifier 236 may be or relate to an Internet Protocol (IP) Address, a Media Access Control (MAC) address, or the like. The identifier 236 may be a unique identifier for facilitating wired and/or wireless communications with the user device 102. The identifier 236 may be associated with a physical location of the backend platform device 101.

The backend platform device 101 may include a data layer 240 comprising one or more flat file systems 242, a data lakehouse 244, one or more relational databases 246, and cache 248 for supporting the generation of customized content based on the user inputs received from the user devices 102. The flat file systems 242 may form the first layer of data ingestion. For example, the flat file systems 242 may store raw data from one or more external providers. The raw data may serve as a primary backup system, ensuring that data is available in case of database or pipeline failures. As an example, the raw data may be stored in one or more data formats (e.g., Parquet, JavaScript Object Notation (JSON), etc.). The data lakehouse 244 may be configured to enable storage and processing of structured and unstructured data. As an example, the data lakehouse 244 may be configured to bridge a gap between data lakes and traditional warehouses by providing a unified approach to handle raw and processed datasets. As an example, the data lakehouse 244 may be configured as a central repository for large-scale data analytics and machine learning workflows. The relational databases 246 may be configured to facilitate structured storage and retrieval for transactional and user-facing data, forming the core of the final data layer. For example, the relational databases 246 may be configured as storage for processed and highly structured data for supporting end-user (e.g., user devices 102) interactions. By using optimized relational schemas, the relational databases 246 may enable seamless user interactions and data integrity. The cache 248 may be configured as a high-speed, in-memory data store for caching frequently accessed data in order to reduce load times, enhance user experience, and improve operational efficiency. For example, the cache 248 may enable real-time retrieval of frequently used data. As an example, the cache 248 may be configured to integrate an adaptive caching mechanism that prioritizes critical user interactions.

The backend platform device 101 may implement the data layer 240 to generate the customized content based one or more user inputs and send the customized content to one or more target recipients (e.g., global journalists, podcast creators, and/or influencers). The customized content may comprise one or more of a pitch communication, a tailored pitch email, a templated press release, a user biography, and/or a post, such as a blog post, a byline post, and/or a social media post. As an example, the backend platform device 101 may generate the pitch communication based on a content item, such as a media article, a blog post, or a user document (e.g., media lists). As an example, the backend platform device 101 may generate a tailored pitch email based on content items associated with a target recipient and based on the pitch communication. As an example, the backend platform device 101 may generate the templated press release based on the pitch communication and based on one or more user inputs associated with the pitch communication. As an example, the backend platform device 101 may generate the user biography based on a type of event, such as a presentation or webinar, and a user profile associated with a webpage. As an example, the backend platform device 101 may generate the post based on any data or statistics available online as well as a product designation and/or keyword.

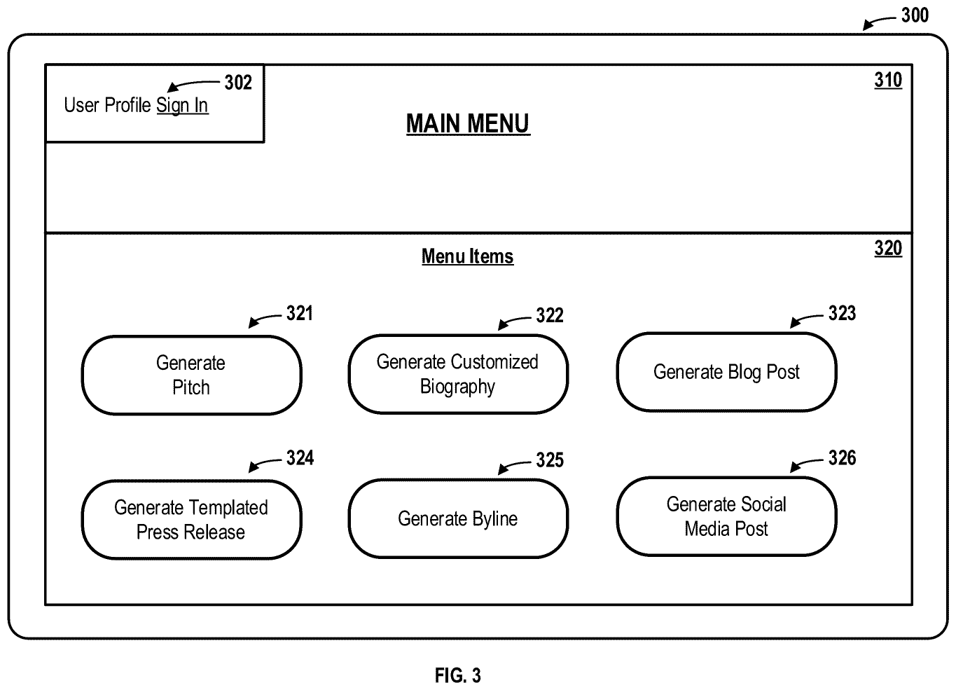

FIG. 3 shows an example user interface 300 that may be output when a user accesses the application 104 via the user device 102. The application 104 may comprise a mobile application or a web browser. The user interface 300 may comprise at least a main menu 310 screen comprising one or more options 320 for generating customized content such as a pitch communication 321, a customized biography 322, a blog post 323, a templated press release 324, a byline 325, or a social media post 326. In addition, the application 104 may output an option to log-in 302 to a user profile. For example, the user may sign in to access a user profile 302 associated with the user. The user profile 302 may include user information for determining one or more user preferences of the user. For example, the user preferences may be associated with an education, a personal interest, or a previous role of the user. In addition, previously generated customized content (e.g., pitch communications, personalized pitch emails, templated press releases, biographies, and/or posts, such as blog posts, bylines, and/or social media posts) may be saved in the user profile for later retrieval.

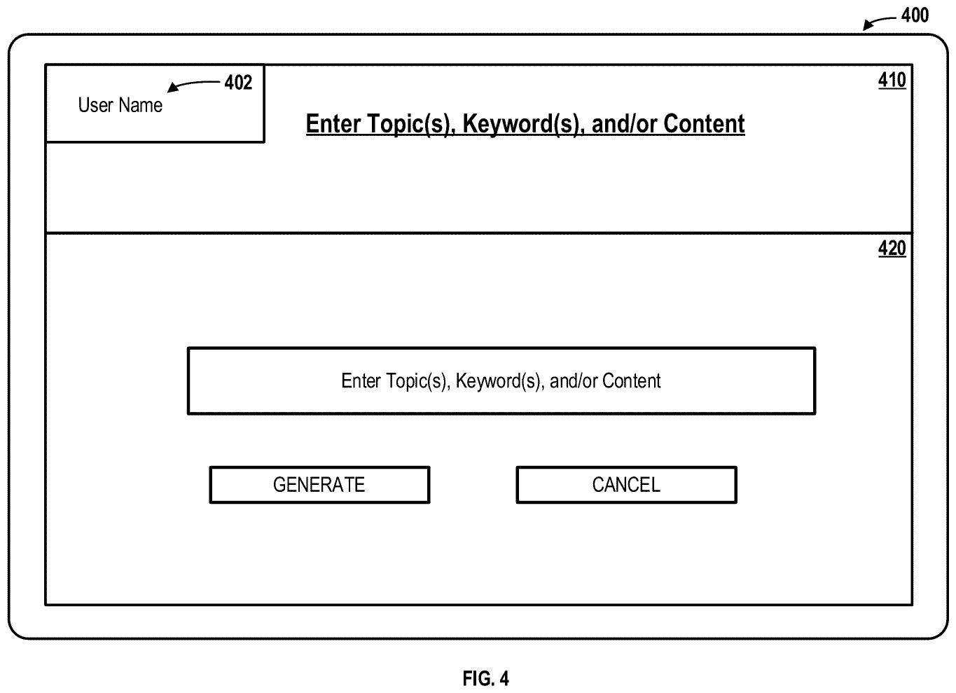

After selecting an option, the application 104 may output an interface 400 for receiving a prompt from the user, as shown in FIG. 4. For example, the application 104 may output the title 410 (e.g., “Enter Prompt”) of the interface and an area in the screen for providing user input 420. In an example, if the user signs in, the user name 402 associated with the user profile may be output via the interface 400. The application 104 may be configured to receive user input (e.g., one or more topics, one or more keywords, and/or one or more content items) via the prompt 420. As an example, the one or more content items may comprise media article, a blog post, or a user document (e.g., media lists). For example, the application 104 may be configured to receive the one or more content items via a drag and drop action from the user via the user device 102. The user may select a content item and drag it to the prompt providing the input for generating the customized content. In another example, the user may copy and paste a content item and/or text into the prompt providing the input for generating the customized content.

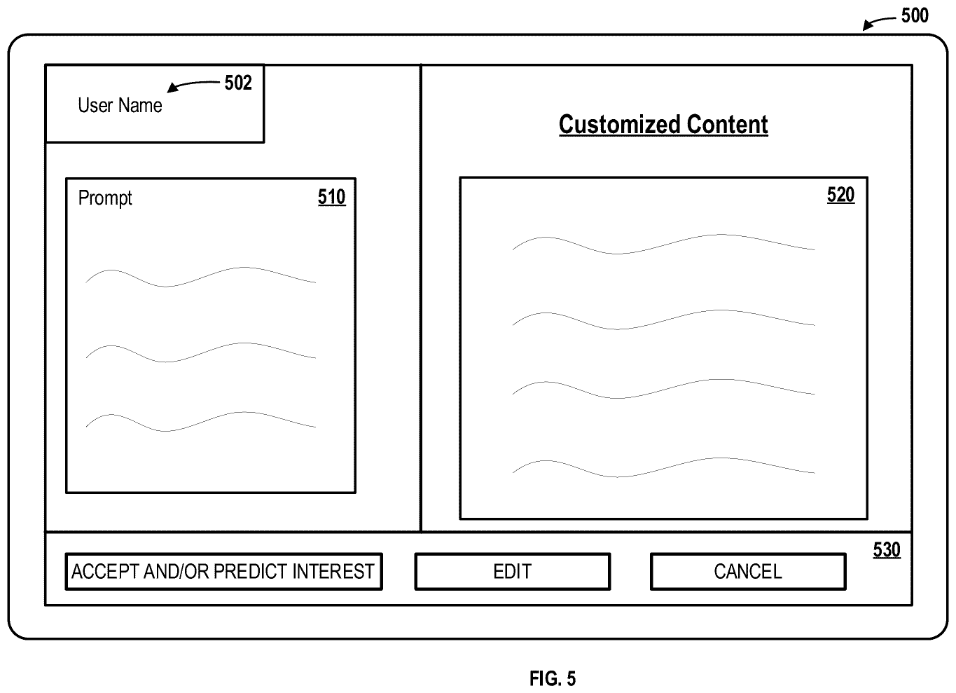

Once the user has provided the user input (e.g., text input, content items, etc.) and selected “Accept,” the application 104 may output an interface 500 that displays the customized content 520, as shown in FIG. 5. For example, the interface 500 may display the prompt 510 that was provided, the customized content 520 (e.g., pitch communication, biography, or blog post), and one or more options 530. One of the options 530 may comprise options for accepting and predicting interest. For example, once the user selects “Accept and Predict Interest” option, the application 104 may compile one or more target recipients (e.g., a list of relevant target recipients) for sending the customized content 520. Another one of the options may comprise an option for enabling the user to edit the customized content. For example, the user may edit the pitch communication, wherein the edited pitch communication may be sent to the one or more target recipients based on the new information in the newly edited pitch communication. In another example, the user may edit the biography or the blog post and send out for distribution (e.g., social media, and/or social media profile). In an example, if the user signs in, the user name 502 associated with the user profile may be output via the interface 500.

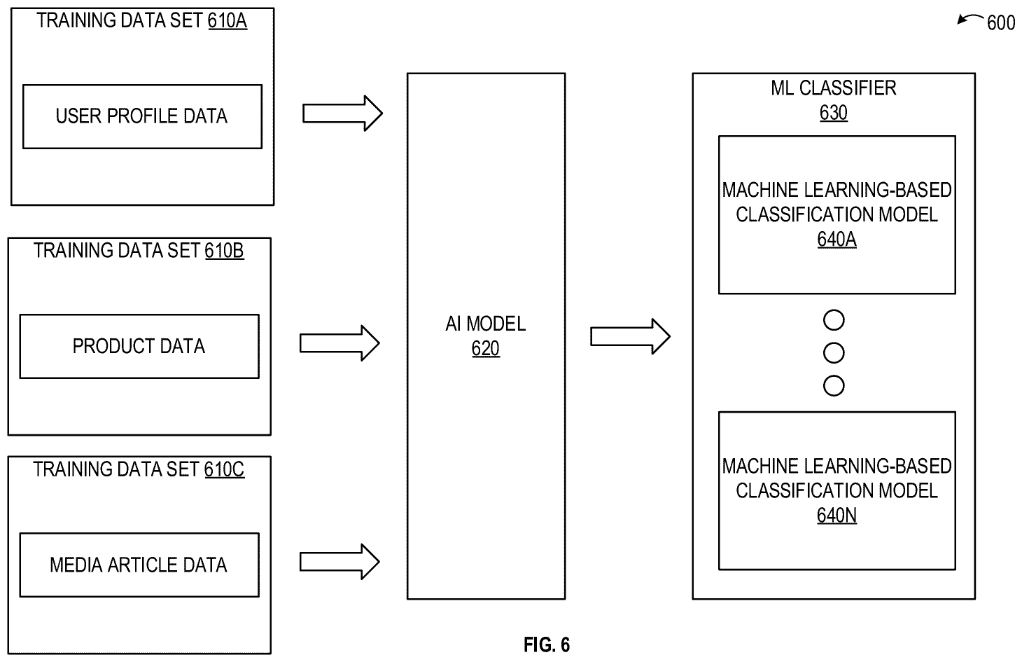

FIG. 6 shows an example system 600 that is configured to use machine learning techniques to train, based on an analysis of one or more training datasets 610A, 610B, 610C by a training module 620, at least one machine learning-based classifier 630. The at least one machine learning model 630, once trained, may be configured to generate a customized content/communication (e.g., pitch communication, user biography, and/or blog post) and send the customized content/communication to one or more target recipients. A dataset indicative of a plurality of user profiles and a plurality of content items and a labeled (e.g., predetermined/known) prediction indicating whether the corresponding content items are of interest to a particular target recipient (e.g., contain one or more content features that may be of interest) or not may be used by the machine learning module 620 to train the at least one machine learning model 530. Each of the plurality of content items in the dataset may be associated with a plurality of features that are present within each corresponding content items that may be correlated to a plurality features associated with the plurality of user profiles. The plurality of features and the labeled predictions may be used to train the at least one machine learning model 630.

The training dataset 610A may comprise a dataset of a plurality of user profiles. Each user profile may have a labeled (e.g., predetermined) prediction and one or more labeled features. The training dataset 610B may comprise a plurality of content items associated with a plurality of products. Each content item associated with a product may have a labeled (e.g., predetermined) prediction and one or more labeled features. The training dataset 610C may comprise a plurality of content items associated with a plurality of media articles (e.g., blog posts, press releases, etc.). Each content item associated with a media article may have a labeled (e.g., predetermined) prediction and one or more labeled features. The plurality of user profiles may be randomly assigned to the training dataset 610A and/or to a testing dataset. The plurality of content items may be randomly assigned to the training dataset 610B, the training dataset 610C, and/or to a testing dataset. In some implementations, the assignment of user profiles and/or content items to a training dataset or a testing dataset may not be completely random. In this case, one or more criteria may be used during the assignment, such as ensuring that similar numbers of user profiles and/or content items with different predictions and/or features are in each of the training and testing datasets. In general, any suitable method may be used to assign the user profiles and/or the content items to the training or testing datasets, while ensuring that the distributions of predictions and/or features are somewhat similar in the training dataset and the testing dataset.

The machine learning module 620 may use portions of the training datasets 610A, 610B, and/or 610C to determine one or more features that are indicative of a high prediction. That is, the machine learning module 620 may determine which features present within the plurality of user profiles and the plurality of content items are correlative with a high prediction. The one or more features indicative of a high prediction may be used by the machine learning module 620 to train the machine learning model 630. For example, the machine learning module 620 may train the machine learning model 630 by extracting a feature set (e.g., one or more features) from a first portion a the training datasets 610A, 610B, and 610C according to one or more feature selection techniques. The machine learning module 620 may further define the feature set obtained from the training datasets 610A, 610B, and 610C by applying one or more feature selection techniques to a second portion in the training datasets 610A, 610B, and 610C that includes statistically significant features of positive examples (e.g., high predictions) and statistically significant features of negative examples (e.g., low predictions). The machine learning module 620 may train the machine learning model 630 by extracting a feature set from the training dataset 610B that includes statistically significant features of positive examples (e.g., high predictions) and statistically significant features of negative examples (e.g., low predictions).

The machine learning module 620 may extract a feature set from the training datasets 610A, 610B, and 610C in a variety of ways. For example, the machine learning module 620 may extract a feature set from the training datasets 610A, 610B, and 610C using a classification module (e.g., a machine learning model). The machine learning module 620 may perform feature extraction multiple times, each time using a different feature-extraction technique. In one example, the feature sets generated using the different techniques may each be used to generate different machine learning models 640. For example, the feature set with the highest quality features (e.g., most indicative of interest or not of interest to a particular user(s)) may be selected for use in training. The machine learning module 620 may use the feature set(s) to build one or more machine learning models 640A-640N that are configured to generate customized content.

The training datasets 610A, 610B, and/or 610C may be analyzed to determine any dependencies, associations, and/or correlations between features and the labeled predictions in the training datasets 610A, 610B, and/or 610C. The identified correlations may have the form of a list of features that are associated with different labeled predictions (e.g., of interest to a particular user vs. not of interest to a particular user). The term “feature,” as used herein, may refer to any characteristic of an item of data that may be used to determine whether the item of data falls within one or more specific categories or within a range. By way of example, the features described herein may comprise one or more features present within each of the content items that may be correlative (or not correlative as the case may be) with a feature being of interest to a particular user or not.

A feature selection technique may comprise one or more feature selection rules. The one or more feature selection rules may comprise a feature occurrence rule. The feature occurrence rule may comprise determining which features in the training datasets 610A, 610B, and 610C occur over a threshold number of times and identifying those features that satisfy the threshold as candidate features. For example, any features that appear greater than or equal to 5 times in the training datasets 610A, 610B, and 610C may be considered as candidate features. Any features appearing less than, for example, 5 times may be excluded from consideration as a candidate feature. Other threshold numbers may be used as well.

A single feature selection rule may be applied to select features or multiple feature selection rules may be applied to select features. The feature selection rules may be applied in a cascading fashion, with the feature selection rules being applied in a specific order and applied to the results of the previous rule. For example, the feature occurrence rule may be applied to the training dataset 610A to generate a first list of features. A final list of features may be analyzed according to additional feature selection techniques to determine one or more candidate feature groups (e.g., groups of features that may be used to determine a prediction). Any suitable computational technique may be used to identify the feature groups using any feature selection technique such as filter, wrapper, and/or embedded methods. One or more candidate feature groups may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms used by the system 600. Instead, features may be selected on the basis of scores in various statistical tests for their correlation with the outcome variable (e.g., a prediction).

As another example, one or more candidate feature groups may be selected according to a wrapper method. A wrapper method may be configured to use a subset of features and train the machine learning model 630 using the subset of features. Based on the inferences that may be drawn from a previous model, features may be added and/or deleted from the subset. Wrapper methods include, for example, forward feature selection, backward feature elimination, recursive feature elimination, combinations thereof, and the like. For example, forward feature selection may be used to identify one or more candidate feature groups. Forward feature selection is an iterative method that begins with no features. In each iteration, the feature which best improves the model is added until an addition of a new variable does not improve the performance of the model. As another example, backward elimination may be used to identify one or more candidate feature groups. Backward elimination is an iterative method that begins with all features in the model. In each iteration, the least significant feature is removed until no improvement is observed on removal of features. Recursive feature elimination may be used to identify one or more candidate feature groups. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

As a further example, one or more candidate feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the machine learning module 620 has generated a feature set(s), the machine learning module 620 may generate the one or more machine learning models 640A-640N based on the feature set(s). A machine learning model (e.g., any of the one or more machine learning models 640A-640N) may refer to a complex mathematical model for data classification that is generated using machine-learning techniques as described herein. In one example, a machine learning model may include a map of support vectors that represent boundary features. By way of example, boundary features may be selected from, and/or represent the highest-ranked features in, a feature set.

The machine learning module 620 may use the feature sets extracted from the training datasets 610A, 610B, and/or 610C to build the one or more machine learning models 640A-640N for each classification category (e.g., “of interest to a particular user content item” and “not of interest to the particular user content item”). In some examples, the one or more machine learning models 640A-640N may be combined into a single machine learning model 540 (e.g., an ensemble model). Similarly, the machine learning model 630 may represent a single classifier containing a single or a plurality of machine learning models 640 and/or multiple classifiers containing a single or a plurality of machine learning models 640 (e.g., an ensemble classifier).

The extracted features (e.g., one or more candidate features) may be combined in the one or more machine learning models 640A-640N that are trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); generative pre-trained transformer; support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning model 630 may comprise a decision rule or a mapping for each candidate feature in order to assign a prediction to a class (e.g., of interest to a particular user vs. not of interest to the particular user). As described herein, the machine learning model 630 may be used to generate customized content. The candidate features and the machine learning model 630 may be used to determine predictions for user profiles and content items in the testing dataset.

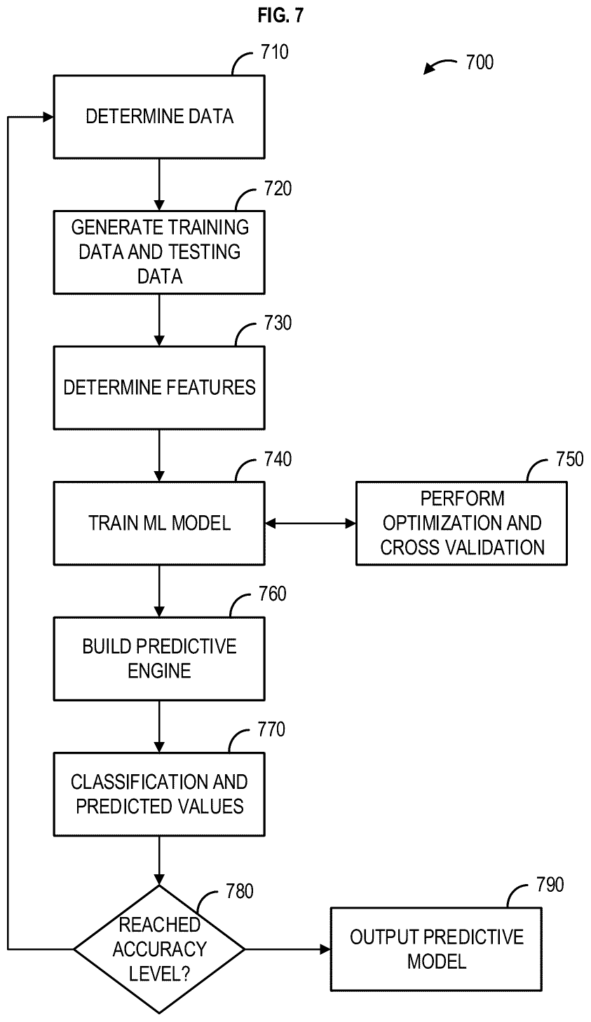

FIG. 7 shows a flowchart of an example training method 700 for generating the machine leaning-based classifier 630 using the training module 620. The training module 620 may be implement using supervised, unsupervised, and/or semi-supervised (e.g., reinforcement based) machine learning-based classification models 640. The method 700 illustrated in FIG. 7 is an example of a supervised learning method; variations of this example of training method are discussed below, however, other training methods may be analogously implemented to train unsupervised and/or semi-supervised machine learning models.

At step 710, the training method 700 may determine (e.g., access, receive, retrieve, etc.) user profiles, content items associated with products, and content items associated with media articles. The user profiles, the content items associated with products, and the content items associated with media articles may each comprise one or more features and a predetermined prediction. The training method 700 may generate, at step 720, a training dataset and a testing dataset. The training dataset and the testing dataset may be generated by randomly assigning user profile data, content item data associated with products, and content item data associated with media articles to either the training dataset or the testing dataset. In some implementations, the assignment of user profiles, content items associated with products, and content items associated with media articles as training or test samples may not be completely random. As an example, only the user profiles and content items for a specific feature(s) and/or range(s) of predetermined predictions may be used to generate the training dataset and the testing dataset. As another example, a majority of the user profiles, the content items associated with products, and the content items associated with media articles for the specific feature(s) and/or range(s) of predetermined predictions may be used to generate the training dataset. For example, 75% of the user profiles and content items for the specific feature(s) and/or range(s) of predetermined predictions may be used to generate the training dataset and 25% may be used to generate the testing dataset.

The training method 700 may determine (e.g., extract, select, etc.), at step 730, one or more features that may be used by, for example, a classifier to differentiate among different classifications (e.g., predictions/recommendations). The one or more features may comprise a set of features. As an example, the training method 700 may determine a set features from the user profiles, the content items associated with products, and the content items associated with media articles. As another example, a set of features may be determined from other me user profiles, content items associated with products, and content items associated with media articles associated with a specific feature(s) and/or range(s) of predetermined predictions that may be different than the specific feature(s) and/or range(s) of predetermined predictions associated with the user profiles and content items of the training dataset and the testing dataset. In other words, the other user profiles, content items associated with products, and content items associated with media articles may be used for feature determination/selection, rather than for training. The training dataset may be used in conjunction with the other user profiles, content items associated with products, and content items associated with media articles to determine the one or more features. The other user profiles, content items associated with products, and content items associated with media articles may be used to determine an initial set of features, which may be further reduced using the training dataset.

The training method 700 may train one or more machine learning models (e.g., one or more machine learning models, neural networks, deep-learning models, text-based learning models, large language models, natural language processing applications/models, generative pre-trained transformers, etc.) using the one or more features at step 740. In one example, the machine learning models may be trained using supervised learning. In another example, other machine learning techniques may be used, including unsupervised learning and semi-supervised. The machine learning models trained at step 740 may be selected based on different criteria depending on the problem to be solved and/or data available in the training dataset. For example, machine learning models may suffer from different degrees of bias. Accordingly, more than one machine learning model may be trained at 740, and then optimized, improved, and cross-validated at step 750.

The training method 700 may select one or more machine learning models to build the machine learning model 630 at step 760. The machine learning model 630 may be evaluated using the testing dataset. The machine learning model 630 may analyze the testing dataset and generate classification values and/or predicted values (e.g., predictions) at step 770. Classification and/or prediction values may be evaluated at step 780 to determine whether such values have achieved a desired accuracy level. Performance of the machine learning model 630 may be evaluated in a number of ways based on a number of true positives, false positives, true negatives, and/or false negatives classifications of the plurality of data points indicated by the machine learning model 630.

For example, the false positives of the machine learning model 630 may refer to a number of times the machine learning model 630 incorrectly assigned a high prediction to a content item associated with a low predetermined prediction. Conversely, the false negatives of the machine learning model 630 may refer to a number of times the machine learning model assigned a low prediction to a content item associated with a high predetermined prediction. True negatives and true positives may refer to a number of times the machine learning model 630 correctly assigned predictions to content item based on the known, predetermined prediction for each content item. Related to these measurements are the concepts of recall and precision. Generally, recall refers to a ratio of true positives to a sum of true positives and false negatives, which quantifies a sensitivity of the machine learning model 630. Similarly, precision refers to a ratio of true positives a sum of true and false positives. When such a desired accuracy level is reached, the training phase ends and the machine learning model 630 may be output at step 790; when the desired accuracy level is not reached, however, then a subsequent iteration of the training method 700 may be performed starting at step 710 with variations such as, for example, considering a larger collection of user profiles and content items. The machine learning model 630 may be output at step 790.

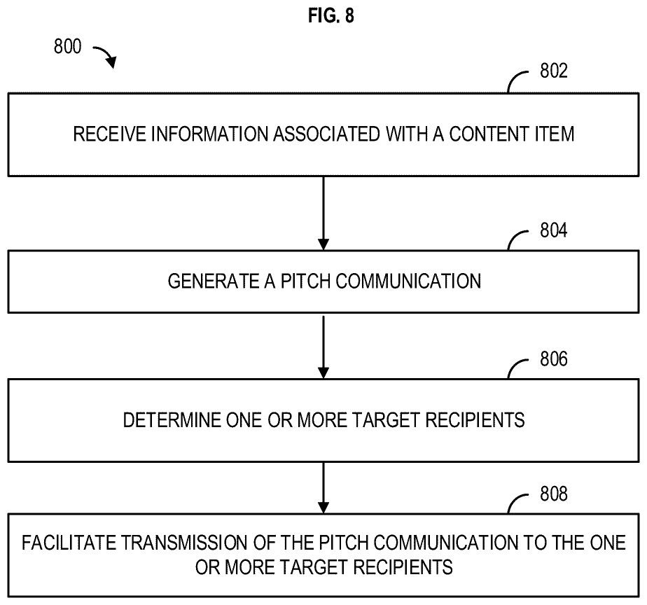

FIG. 8 shows a flowchart of an example method 800 for generating a pitch communication. Method 800 may be implemented by a computing device (e.g., backend platform device 101, servers 106, etc.). At step 802, information associated with a content item may be received. For example, the information associated with a content item may be received by the computing device (e.g., backend platform device 101, servers 106, etc.). The content item may comprise one or more of a media article, a blog post, or a user document (e.g., media lists).

At step 804, a pitch communication may be generated based on the information. For example, the computing device (e.g., backend platform device 101, servers 106, etc.) may generate the pitch communication based on the information via a generative artificial intelligence (AI) module. The pitch communication may be related to, or associated with, a potential media placement for the content item. In an example, the generative AI module may analyze the information to identify thematic elements. The generative AI module may determine a narrative encompassing the identified thematic elements. The generative AI module may generate the pitch communication based on the narrative. As an example, one or more tailored pitch emails may be generated by the generative AI module based on one or more content items associated with each target recipient of the one or more target recipients and based on the pitch communication. One or more inputs associated with each tailored pitch email of the one or more tailored pitch emails may be received. The one or more tailored pitch emails may be sent (e.g., transmitted) to the one or more target recipients based on the one or more inputs associated with each tailored pitch email. As an example, the user may provide one or more user inputs editing one or more of the tailored pitch emails before the one or more tailored pitch emails are sent to the one or more target recipients.

At step 806, one or more target recipients may be determined. For example, the computing device (e.g., backend platform device 101, servers 106, etc.) may determine the one or more target recipients based on the pitch communication via a predictive AI module. The target recipients may comprise journalists, podcast creators, influencers and the like. In an example, the one or more target recipients may be determined based on one or more filter parameters comprising one or more of a location or a source. In an example, the predictive AI module may determine recipient receptiveness associated with one or more recipients based on the pitch communications. The one or more target recipients may be determined based on the recipient receptiveness associated with the one or more recipients. In an example, the predictive AI module may analyze a plurality of recipient profiles to identify one or more potential recipients based on historical receptiveness data and thematic preferences. An alignment between the pitch communication and the one or more potential recipients using predictive analytics may be evaluated. The one or more target recipients may be determined of the one or more potential recipients predicted to be most receptive to the pitch communication based on the evaluative analysis. The plurality of recipient profiles may comprise data accumulated from a plurality sources comprising one or more of media publications, social media platforms, or previous engagement histories. The predictive AI module may be configured to employ a sentiment analysis algorithm to gauge potential receptiveness of the one or more potential recipients based on their recent publications and social media sentiment.

As an example, one or more user inputs associated with the pitch communication may be received. A templated press release communication may be generated, via the generative AI module, based on the one or more user inputs associated with the pitch communication and based on the pitch communication. One or more second target recipients may be determined, via the predictive AI module, based on the templated press release communication. The templated press release communication may be sent to the one or more second target recipients.

At step 808, the pitch communication may be sent (e.g., transmitted) to the one or more target recipients. For example, the computing device (e.g., backend platform device 101, servers 106, etc.) may facilitate the transmission of the pitch communication to the one or more target recipients.

As an example, a response from the target recipients may be provided to a feedback loop mechanism to update the predictive AI module. As an example, one or more engagement metrics associated with the one or more target recipients engaging with the pitch communication may be tracked. As an example, one or more user inputs editing the pitch communication may be received. One or more second target recipients may be determined by the predictive AI module based on the edited pitch communication. The computing device (e.g., backend platform device 101, servers 106, etc.) may facilitate the transmission of the edited pitch communication to the one or more second target recipients.

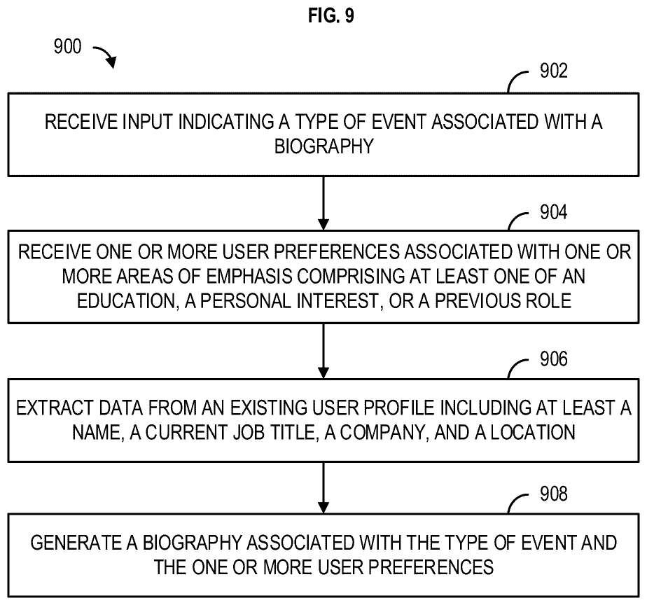

FIG. 9 shows a flowchart of an example method 900 for generating a biography for a user. Method 900 may be implemented by a computing device (e.g., backend platform device 101, servers 106, etc.). At step 902, input indicating a type of event associated with a biography may be received. For example, a computing device (e.g., backend platform device 101, servers 106, etc.) may receive the input indicating the type of event associated with the biography from a user device (e.g., user device 102). The type of event may be associated with a presentation (e.g., a webinar) and/or topics associated with an event.

At step 904, one or more user preferences associated with one or more areas of emphasis comprising at least one of an education, a personal interest, or a previous role may be received. For example, the computing device (e.g., backend platform device 101, servers 106, etc.) may receive the one or more user preferences associated with one or more areas of emphasis comprising at least one of an education, a personal interest, or a previous role from a user device (e.g., user device 102). The one or more areas of emphasis may be weighted according to user preferences to prioritize information in the generated biography. In an example, the one or more user preferences may be provided by the user device based on a user profile. The user profile, and/or the one or more user preferences based on the user profile, may be sent to the computing device when the user device sends/provides the input indicating the type of event associated with the biography. In an example, the one or more preferences may be provided based on a user profile associated with a webpage (e.g., social media profile).

At step 906, data may be extracted from an existing user profile including at least a name, a current job title, a company, and a location. For example, the data may be extracted by the computing device (e.g., backend platform device 101, servers 106, etc.) from an existing user profile including at least a name, a current job title, a company, and a location. In an example, an identifier (e.g., a URL, a link, etc.) associated with a webpage may be received. The existing user profile may be determined based on the identifier associated with the webpage. The webpage may comprise a social media webpage (e.g., professional social media webpage) associated with a user. For example, the webpage may comprise structured data indicative of user characteristics comprising at least the name, the current job title, the company, and the location. In an example, a profile photo may be extracted from the existing user profile, wherein the photo may be incorporated into a user biography. In an example, the computing device may be configured to facilitate, via an application programming interface (API), the extraction of the data from the existing user profile.

At step 908, a biography associated with the type of event and the one or more user preferences may be generated. For example, the computing device (e.g., backend platform device 101, servers 106, etc.) may generate the biography associated with the type of event and the one or more user preferences via a generative AI module. In an example, the generative AI module may utilize natural language processing to generate the biography associated with the type of event and the one or more user preferences. As an example, an option to edit the generated biography may be provided. As an example, the generated biography may be formatted according to a template selected based on the type of event.

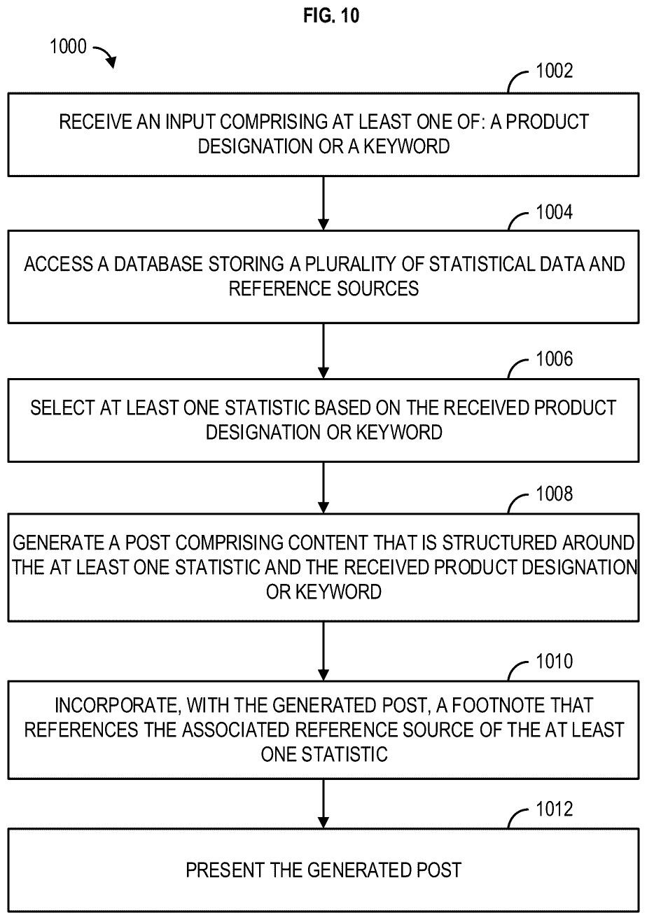

FIG. 10 shows a flowchart of an example method 1000 for generating a post (e.g., a blog post, a byline post, and/or a social media post). Method 1000 may be implemented by a computing device (e.g., backend platform device 101, servers 106, etc.). At step 1002, an input comprising at least one of a product designation or a keyword may be received via a user interface. For example, the computing device (e.g., backend platform device 101, servers 106, etc.) may receive input comprising at least one of a product designation or a keyword via the user interface.

At step 1004, a database storing a plurality of statistical data and reference sources may be accessed. For example, the computing device (e.g., backend platform device 101, servers 106, etc.) may access the database storing the plurality of statistical data and reference sources via a generative AI module.

At step 1006, at least one statistic based on the received product designation or keyword may be selected. For example, the computing device (e.g., backend platform device 101, servers 106, etc.) may select the at least one statistic based on the received product designation or keyword via the generative AI module. The at least one statistic may have an associated reference source indicating an origin of the at least one statistic.

At step 1008, a post comprising content that is structured around the at least one statistic and the received product designation or keyword may be generated by the generative AI module. For example, the computing device (e.g., backend platform device 101, servers 106, etc.) may generate, via the generative AI module, the post comprising content that is structured around the at least one statistic and the received product designation or keyword. The post may comprise one or more of a blog post, a byline post, or a social media post. As an example, the blog post and the byline post may comprise similar content, wherein the blog post may contain 500 or less words while the byline post may contain 500 or more words. As an example the social media post may contain content tailored for one or more social media platforms. In an example, the generative AI module may be configured to utilize a linguistic model to create a coherent and contextually relevant narrative surrounding the selected statistic and the received product designation or keyword. For example, the linguistic model utilized by the generative AI module may be configured for understanding and processing natural language inputs to create grammatically correct and stylistically consistent narrative content.

At step 1010, a footnote that references the associated reference source of the at least one statistic may be incorporated within the generated post. For example, the computing device (e.g., backend platform device 101, servers 106, etc.) may incorporate the footnote that references the associated reference source of the at least one statistic within the generated post.

At step 1012, the post may be generated. For example, the computing device (e.g., backend platform device 101, servers 106, etc.) may generate the post via a user interface of the user device (e.g., user device 102). In an example, the computing device may be further configured to provide, via the user interface, one or more options associated with the generated post. The one or more options may comprise one or more of edit the post, save the post, send the post to a social media platform, or reference one or more previous generations of the post. In an example, the user interface may be configured to further provide options for a user to specify additional criteria for the post generation. The additional criteria may comprise one or more of a length of the post, a desired writing style, a topic of the post, a tone of the post, a product, a keyword, or inclusion of multimedia elements.

As an example, the database storing the plurality of statistical data and reference sources may be updated to include recent statistical data and reference sources. As an example, the generated post for search engine visibility (SEO) may be optimized by incorporating at least one SEO-friendly element based on the received product designation or keyword.

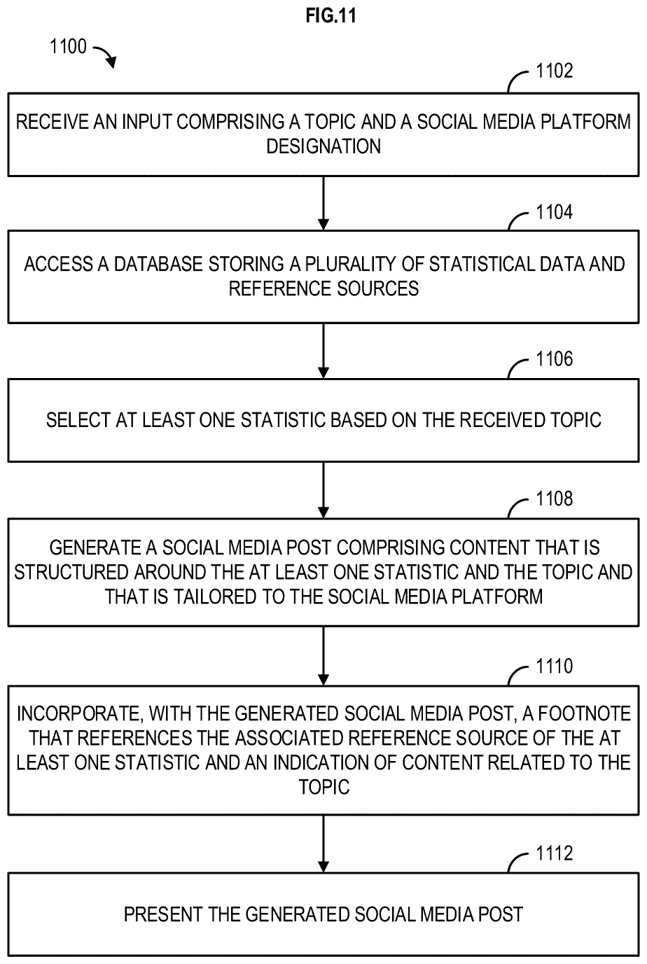

FIG. 11 shows a flowchart of an example method 1100 for generating a social media post. Method 1100 may be implemented by a computing device (e.g., backend platform device 101, servers 106, etc.). At step 1102, an input comprising a topic and a social media platform designation may be received via a user interface. For example, the computing device (e.g., backend platform device 101, servers 106, etc.) may receive input comprising the topic and the social media platform designation via the user interface.

At step 1104, a database storing a plurality of statistical data and reference sources may be accessed. For example, the computing device (e.g., backend platform device 101, servers 106, etc.) may access the database storing the plurality of statistical data and reference sources via a generative AI module.

At step 1106, at least one statistic based on the received topic may be selected. For example, the computing device (e.g., backend platform device 101, servers 106, etc.) may select the at least one statistic based on the received topic via the generative AI module. The at least one statistic may have an associated reference source indicating an origin of the at least one statistic.

At step 1108, a social media post comprising content that is structured around the topic and that is tailored to the social media platform may be generated by the generative AI module. For example, the computing device (e.g., backend platform device 101, servers 106, etc.) may generate, via the generative AI module, the post comprising content that is structured around the topic and that is tailored to the social media platform. In an example, the generative AI module may be configured to utilize a linguistic model to create a coherent and contextually relevant narrative surrounding the selected statistic and the received topic. For example, the linguistic model utilized by the generative AI module may be configured for understanding and processing natural language inputs to create grammatically correct and stylistically consistent narrative content.

At step 1110, a footnote that references the associated reference source of the at least one statistic and an indication of content related to the topic may be incorporated within the generated social media post. For example, the computing device (e.g., backend platform device 101, servers 106, etc.) may incorporate the footnote that references the associated reference source of the at least one statistic and the indication of content related to the topic within the generated social media post. The content may comprise one or more of one or more video content items associated with the topic or one or more audio content item items associated with the topic.

At step 1112, the post may be generated. For example, the computing device (e.g., backend platform device 101, servers 106, etc.) may generate the post via a user interface of the user device (e.g., user device 102). In an example, the computing device may be further configured to provide, via the user interface, one or more options associated with the generated post. The one or more options may comprise one or more of edit the post, save the post, send the post to the social media platform, or reference one or more previous generations of the post. In an example, the user interface may be configured to further provide options for a user to specify additional criteria for the post generation. The additional criteria may comprise one or more of a length of the post, a desired writing style, a topic of the post, a tone of the post, a product, a keyword, or inclusion of multimedia elements.

The methods and systems can employ artificial intelligence (AI) techniques such as machine learning and iterative learning. Examples of such techniques comprise, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, such as: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

What is claimed is:

1. A method for utilizing generative artificial intelligence (AI) to facilitate public relations (PR) activities, the method comprising:
receiving, by a computing device, information associated with a content item;
generating, by a generative AI module, based on the information, a pitch communication;
determining, by a predictive AI module, based on the pitch communication, one or more target recipients; and
facilitating, by the computing device, transmission of the pitch communication to the one or more target recipients.

2. The method of claim 1, wherein the content item comprises one or more of a media article, a blog post, or a user document.

3. The method of claim 1, wherein generating, by the generative AI module, based on the information, the pitch communication comprises:
analyzing, by the generative AI module, the information to identify thematic elements;
determining a narrative encompassing the identified thematic elements; and
generating, based on the narrative, the pitch communication.

4. The method of claim 1, further comprising:
generating, by the generative AI module, based on one or more content items associated with each target recipient of the one or more target recipients and based on the pitch communication, one or more tailored pitch emails; and
receiving one or more inputs associated with each tailored pitch email of the one or more tailored pitch emails;
facilitating, by the computing device, based on the one or more inputs associated with each tailored pitch email, transmission of the one or more tailored pitch emails to the one or more target recipients.

5. The method of claim 1, further comprising determining the one or more target recipients based on one or more filter parameters, wherein the one or more filter parameters comprises one or more of a location or a source.

6. The method of claim 1, wherein determining, by the predictive AI module, based on the pitch communication, the one or more target recipients comprises:
determining, by the predictive AI module, based on the pitch communication, recipient receptiveness associated with one or more recipients; and
determining, based on the recipient receptiveness associated with the one or more recipients, the one or more target recipients.

7. The method of claim 1, wherein determining, by the predictive AI module, based on the pitch communication, the one or more target recipients comprises:
analyzing, by the predictive AI module, based on historical receptiveness data and thematic preferences, a plurality of recipient profiles to identify one or more potential recipients;
evaluating an alignment between the pitch communication and the one or more potential recipients using predictive analytics; and
determining, based on the evaluative analysis, the one or more target recipients of the one or more potential recipients predicted to be most receptive to the pitch communication.

8. The method of claim 1, further comprising:
receiving one or more user inputs associated with the pitch communication;
generating, by the generative AI module, based on the one or more user inputs and the pitch communication, a press release communication;
determining, by the predictive AI module, based on the press release communication, one or more second target recipients; and
facilitating, by the computing device, transmission of the press release communication to the one or more second target recipients.

9. A method for generating a customized biography for a user, the method comprising:
receiving input indicating a type of event associated with a biography;
receiving one or more user preferences associated with one or more areas of emphasis comprising at least one of an education, a personal interest, or a previous role;
extracting data from an existing user profile including at least a name, a current job title, a company, and a location; and
generating, via a generative artificial intelligence (AI) module, a biography associated with the type of event and the one or more user preferences.

10. The method of claim 9, further comprising:
receiving an identifier associated with a webpage, wherein the identifier comprises a URL or a link, wherein the webpage comprises structured data indicative of user characteristics, and wherein the user characteristics comprise at least the name, the current job title, the company, and the location; and
determining the existing user profile based on the identifier associated with the webpage.

11. The method of claim 9, further comprising extracting a profile photo from the existing user profile and incorporating the profile photo into the generated biography.

12. The method of claim 9, wherein generating, via the generative AI module, the biography associated with the type of event and the one or more user preferences comprises utilizing, by the generative AI module, natural language processing.

13. The method of claim 9, further comprising formatting the generated biography according to a template selected based on the type of event.

14. The method of claim 9, wherein the areas of emphasis are weighted according to user preferences to prioritize information in the generated biography.

15. A method for generating a post using a generative artificial intelligence (AI) module, the method comprising:
receiving, via a user interface, an input comprising at least one of: a product designation or a keyword;
accessing, by a generative AI module, a database storing a plurality of statistical data and reference sources;
selecting, by the generative AI module, at least one statistic based on the received product designation or keyword, wherein the at least one statistic has an associated reference source indicating an origin of the at least one statistic;
generating, by the generative AI module, a post comprising content that is structured around the at least one statistic and the received product designation or keyword;
incorporating, within the generated post, a footnote that references the associated reference source of the at least one statistic; and
presenting, via the user interface, the generated post.

16. The method of claim 15, wherein the post comprises one or more of a byline post, a blog post, or a social media post.

17. The method of claim 15, further comprising providing one or more options, via the user interface, associated with the generated post, wherein the one or more options comprise one or more of edit the post, save the post, send the post to a social media platform, or reference one or more previous generations of the post.

18. The method of claim 15, wherein the generative AI module is configured to utilize a linguistic model to create a coherent and contextually relevant narrative surrounding the at least one statistic and the received product designation or keyword.

19. The method of claim 18, wherein the linguistic model utilized by the generative AI module is configured for understanding and processing natural language inputs to create grammatically correct and stylistically consistent narrative content.

20. The method of claim 15, wherein the user interface further provides options for a user to specify additional criteria for the post generation, wherein the additional criteria comprise one or more of: a length of the post, a desired writing style, a topic of the post, a tone of the post, a product, a keyword, or inclusion of multimedia elements.
